(19) United States
(12) Patent Application Publication
(10) Pub. No.: US 2023/0117322 A1
(43) Pub. Date: Apr. 20, 2023

(54) REMOVABLE ELECTRIC PROPULSION SYSTEM FOR A ROLLING OBJECT WITH A DEVICE FOR RELEASING THE HANDLEBAR

(71) Applicant: IFP Energies nouvelles, RUEIL-MALMAISON (FR)

(72) Inventors: Stephane VENTURI, RUEIL-MALMAISON CEDEX (FR); Bertrand LECOINTE, RUEIL-MALMAISON CEDEX (FR)

(21) Appl. No.: 17/913,964

(22) PCT Filed: Mar. 12, 2021
(86) PCT No.: PCT/EP2021/056289

§ 371 Date: Sep. 23, 2022

(30) Foreign Application Priority Data
Mar. 25, 2020 (FR) 2002893

(51) Int. Cl. A61G 5/04; A61G 5/00; A61G 5/10; A61G 7/08

(52) U.S. Cl. CPC A61G 5/047; A61G 5/003; A61G 5/1051; A61G 7/08; B62K 5/023

(57) ABSTRACT

The present invention relates to a removable electric propulsion system (1) intended to be coupled to a rolling object. Propulsion system (1) comprises a frame (2) provided with at least one wheel (3) driven by an electric machine, and at least one non-driven wheel (4), a handlebar (20) and means (5) for coupling the propulsion system to the rolling object, coupling means (5) comprising means for gripping and lifting at least one wheel of the rolling object. Handlebar (20) comprises a connection with frame (2) and/or driven wheel (3). Furthermore, the connection comprises a means (12) for locking/unlocking the handlebar relative to frame (2) and/or to a driven wheel (3) from a locking position where handlebar (20) is attached to frame (2) and/or to driven wheel (3), this locked position of handlebar (20) enabling electric propulsion system (1) to be moved by means of handlebar (20), to an unlocking position enabling at least free motion of handlebar (20) relative to frame (2) and/or driven wheel (3).

### FIELD OF THE INVENTION

The invention relates to the field of transport of rolling objects, in particular rolling beds, hospital beds for example.

Moving heavy rolling loads can lead to difficulties for users, in particular if this action is repeated, such as musculoskeletal disorders.

### BACKGROUND OF THE INVENTION

In order to make the motion of heavy rolling loads easier and more ergonomic, it has been considered to equip these heavy loads with electric machines. For example, a first idea has consisted in providing each hospital bed with an electric wheel drive system. Such a solution is expensive because it requires changing or modifying all the beds, which hospitals cannot afford. Furthermore, the drive system and its battery increase the weight of the bed. Therefore, when the battery is discharged, the effort required to move the bed is greater.

Similarly, in the field of logistics or trade, it has been envisaged to make all trolleys electric. Again, such a solution is expensive.

One alternative is to provide a removable propulsion system for rolling objects. Several technical solutions have been considered.

For example, patent application WO-01/85,086 describes a motorized propulsion system for a bed. The propulsion system is configured for coupling to one or more points of the bed. Due to the coupling means provided for this propulsion system, this system cannot be universal and suitable for different rolling objects. Indeed, it cannot be coupled to a rolling object not provided with a coupling part. In addition, for this propulsion system, all the wheels of the rolling object remain in contact with the floor. Therefore, the orientation of the coupled assembly (propulsion system and bed) is more complicated, the frictional forces are high and the motorized wheel requires more power. Besides, the system comprises a handlebar positioned behind the bed, which involves a significant longitudinal dimension.

Patent application WO-2012/171,079 describes a second propulsion system for a hospital bed. The propulsion system is configured to lift two wheels of the bed. However, the wheel gripping mechanism is complex and bulky: the lateral dimension (direction parallel to the axis of the motorized wheels) is great (greater than the width of the bed wheels) and it can exceed the lateral dimensions of the bed, which may be inconvenient for moving the bed, in particular in a reduced space such as a hospital corridor or lift. In addition, the system comprises a handlebar positioned behind the bed, which involves a significant longitudinal dimension.

Patent application WO-2013/156,030 describes a third propulsion system for a hospital bed. The propulsion system is configured to lift two wheels of the bed. However, the system has great lateral (direction parallel to the axis of the motorized wheels) and longitudinal (direction perpendicular to the axis of the wheels) dimensions: the rear platform protrudes from the bed and the distance between the non-motorized wheels can exceed the dimensions of the bed, which may be inconvenient for moving the bed, in particular in a reduced space such as a hospital corridor or lift. Besides, the system comprises a handlebar positioned behind the bed, which involves a significant longitudinal dimension.

The present invention aims to solve the problems of the prior art, notably those related to space requirement and more particularly longitudinal size problems, in the direction of displacement of the rolling object coupled to the system. The system can also be adapted to various rolling objects and provide high maneuverability, notably in limited spaces.

The present invention therefore relates to a removable electric propulsion system intended to be coupled to a rolling object. The propulsion system comprises a frame provided with at least one wheel driven by an electric machine, and at least one non-driven wheel, a handlebar and means for coupling the propulsion system to the rolling object, the coupling means comprising means for gripping and lifting at least one wheel of the rolling object. The handlebar comprises a connection with the frame and/or the driven wheel. Furthermore, the connection comprises a means for locking/unlocking the handlebar relative to the frame and/or to a driven wheel from at least one (locked) position where the handlebar is attached to the frame and/or to the driven wheel, this (or these) locked position(s) of the handlebar enabling the electric propulsion system to be moved by means of the handlebar, to an (unlocked) position enabling at least free motion of the handlebar relative to the frame and/or to the driven wheel, so as to retract the handlebar (or fold away the handlebar, i.e. position it in a place where it occupies reduced space, notably to limit the longitudinal dimension thereof, without causing displacement and/or orientation of the electric propulsion system).

### SUMMARY OF THE INVENTION

The invention relates to a removable electric propulsion system for a rolling object, said propulsion system comprising a frame provided with at least one wheel driven by an electric machine, and at least one non-driven wheel, a handlebar and means for coupling said propulsion system to said rolling object. Said coupling means comprise means for gripping and lifting at least one wheel of said rolling object, and said handlebar comprises a connection with said frame and/or said driven wheel. Besides, said connection comprises a means for locking/unlocking said handlebar relative to said frame and/or to a driven wheel from at least one locking position where the handlebar is attached to said frame (2) and/or to said driven wheel, this at least one locking position of said handlebar enabling the electric propulsion system to be moved by means of said handlebar, to an unlocking position enabling at least free motion of said handlebar relative to said frame or to said driven wheel.

Advantageously, said locking/unlocking means comprises an axle, said axle being preferably attached to the frame or to said driven wheel.

According to a variant of the invention, said locking/unlocking means comprises two locking positions, a first locking position connecting said handlebar to said frame and a second locking position connecting said handlebar to said driven wheel.

Preferably, said coupling means comprise means for orienting at least one wheel of said rolling object in a direction forming a non-zero angle with the longitudinal direction of said frame of said propulsion system. Preferably, said coupling means comprise means for orienting at least one wheel of said rolling object in a direction substantially perpendicular to the longitudinal direction of said frame of said propulsion system.

Advantageously, said electric propulsion system comprises a control means for controlling said locking/unlocking means.

According to an embodiment, said handlebar comprises an arm, the arm being preferably articulated.

Preferably, the arm comprises a connecting piece and a rod, said connecting piece comprising said locking/unlocking means, and said rod being articulated relative to said connecting piece around a first horizontal axle.

Advantageously, said handlebar comprises an operating piece and a blocking/unblocking means, said blocking/unblocking means connecting said operating piece to said rod.

According to an advantageous implementation, said control means controls said locking/unlocking means and said blocking/unblocking means, preferably simultaneously.

According to a variant, said blocking/unblocking means comprises at least two configurations, a first configuration wherein said operating piece is pivotally connected around a second axle relative to said rod, and a second configuration wherein said operating piece is rigidly attached to said rod.

According to an embodiment of the invention, said handlebar comprises a control panel.

Furthermore, the invention relates to a method for retracting said handlebar of a system according to one of the above features, wherein at least the following steps are carried out:
unlocking said locking/unlocking means, said handlebar can then move freely relative to said frame and/or to said driven wheel,
moving said handlebar.

Preferably, the steps are carried out after coupling said rolling object to said removable electric propulsion system.

According to an implementation of the invention, said blocking/unblocking means is unblocked, preferably simultaneously with unlocking said locking/unlocking means.

Advantageously, after moving said handlebar, said operating piece is pivoted.

The invention further relates to a method for steering the removable electric propulsion system by means of said handlebar, wherein at least the following steps are carried out:
connecting said handlebar to said frame and/or to said driven wheel, preferably automatically or semi-automatically, using said locking/unlocking means, said handlebar being rigidly attached to said frame and/or to said driven wheel,
acting upon said handlebar so as to move and/or orient the removable electric propulsion system.

Preferably, said operating piece is blocked at said rod by said blocking/unblocking means, preferably simultaneously with locking said handlebar at said frame and/or said driven wheel using said locking/unlocking means.

### BRIEF DESCRIPTION OF THE FIGURES

Other features and advantages of the system and of the methods according to the invention will be clear from reading the description hereafter of embodiments given by way of non-limitative example, with reference to the accompanying figures wherein:

FIG. 1 is a top view of a propulsion system according to an embodiment of the invention,

FIG. 2 is a side view of a propulsion system according to a first variant embodiment of the invention,

FIG. 3 is a side view of a propulsion system according to a second variant embodiment of the invention,

FIG. 4 is a top view of a propulsion system according to an embodiment coupled to a rolling object,

FIG. 5 is a side view showing a first embodiment of the connection between the handlebar and the frame of the system according to the invention,

FIG. 6 is a side view showing an embodiment of the connection between the handlebar and the driven wheel of the system according to the invention,

FIG. 7 shows a variant of the handlebar of the system according to the invention in position 20′ in FIG. 1,

FIG. 8 shows a variant of the handlebar of the system according to the invention in position 20″ in FIG. 1,

FIG. 9 shows a variant of the handlebar of the system according to the invention in position 20′″ in FIG. 1,

FIG. 10 shows an advantageous variant of the locking/unlocking means of the system according to the invention in unlocking position,

FIG. 11 shows the advantageous variant of the locking/unlocking means of the system according to the invention of FIG. 10 in a first locking position, connected to the frame,

FIG. 12 shows the advantageous variant of the locking/unlocking means of the system according to the invention of FIG. 10 in a second locking position, connected to the driven wheel,

FIG. 13 is a top view of a propulsion system according to a first embodiment coupled to a rolling object, with the major part of the propulsion system positioned beneath the rolling object,

FIG. 14 is a top view of a propulsion system according to a second embodiment coupled to a rolling object, with the major part of the propulsion system positioned beneath the rolling object, and

FIG. 15 is a top view of a propulsion system according to the second embodiment coupled to a rolling object, with the major part of the propulsion system positioned beneath the rolling object, and the operating piece oriented along the longitudinal axis.

### DETAILED DESCRIPTION OF THE INVENTION

The present invention relates to an electric propulsion system for a rolling object. An electric propulsion system is understood to be a removable system for assisting the motion of the rolling object in order to limit the forces required for moving the rolling object. This electric propulsion system comprises at least one electric machine for driving it. A rolling object is an object comprising at least two wheels in order to move it.

The rolling object can have any form, it can notably be a rolling bed, in particular such as those used in hospitals, a wheelchair, a trolley, such as those used for logistics, hospital logistics or commercial logistics (such as a shopping trolley) for example, any rolling furniture. Such a rolling object comprises at least two wheels, preferably three or four. Advantageously, at least one wheel, preferably two wheels of the rolling object are idle wheels, in other words, off-centered wheels orientable around a vertical axis. The rolling object is preferably non-motorized.

The electric propulsion system according to the invention comprises:
a frame provided with at least one motorized wheel, i.e. a wheel driven by an electric machine, and at least one non-motorized wheel, preferably two, i.e. not driven by an electric machine,
a handlebar notably allowing a user to handle, move and orient the propulsion system when the handlebar is necessary,
means for coupling the propulsion system to a rolling object, the coupling means comprise means for gripping and lifting at least one wheel of the rolling object, preferably more wheels of the rolling object, and more preferably two wheels of the rolling object. In other words, the coupling means are configured to grip (grab) and lift at least one wheel of the rolling object. By lifting some wheels of the rolling object, the frictional forces of the coupled assembly are reduced. Thus, the force that needs to be exerted by the user to move the rolling object coupled to the electric propulsion system is reduced.

Coupling the rolling object to the propulsion system is thus achieved by at least one wheel of the rolling object, preferably at least one idle wheel of the rolling object. Therefore, the rolling object does not need to be adapted for the electric propulsion system, which makes the electric propulsion system universal for various rolling objects.

In the rest of the description, the terms “longitudinal”, “transverse”, “horizontal” and “vertical” determine the axes and/or directions of the propulsion system when the propulsion system rests on a flat and level floor (i.e. a floor with no slope, in other words, there is no difference in altitude on the floor) and is in operation (in particular, the wheels of the system rest on the floor).

The longitudinal direction corresponds to the principal direction of displacement of the electric propulsion system.

The transverse direction is orthogonal to the longitudinal direction of the system in the horizontal plane.

The vertical direction is orthogonal to the horizontal plane of the system.

According to an alternative, the motorized wheel can be orientable relative to the frame along a vertical orientation axis (the axis being vertical when the system rests on a flat and level floor). In other words, the motorized wheel can pivot relative to the frame around a vertical orientation axis. This embodiment substantially amounts to controlling the motion of a pallet truck type system.

Preferably, each motorized wheel is an orientable off-centered wheel (also referred to as idle wheel). An orientable off-centered wheel is understood to be a wheel connected to the frame by a pivot connection of substantially vertical axis, and the axis of the wheel is not secant with the axis of the pivot providing connection between the concerned wheel and the frame. Indeed, since no point is common to the axis of the driven wheel and the axis of the pivot connecting it to the frame, the wheel is off-centered relative to the axis of the pivot connecting it to the frame. This off-centered position generates self-orientation of the driven wheel in the direction of the motion. The driven wheel is thus automatically oriented in the direction of the motion imparted by the user through the agency of the driven object or the handlebar. The system can therefore be steered without requiring any action on the handlebar. For example, when the system is coupled to a rolling object, an action on the rolling object allows the propulsion system to be oriented in the desired direction.

According to an implementation of the invention, the non-motorized wheels can be idle wheels, i.e. off-centered wheels orientable around a vertical axis (the axis being vertical when the system rests on a flat and level floor). In other words, the non-motorized wheels can pivot relative to the frame around a vertical orientation axis, and the rotation axis of the wheel can be off-centered (non-concurrent) relative to the vertical orientation axis.

Alternatively, the non-motorized wheels can be orientable around a vertical axis (the axis being vertical when the system rests on a flat and level floor) in a non-off-centered manner. In other words, the non-motorized wheels can pivot relative to the frame around a vertical orientation axis, and the rotation axis of the wheel is aligned with this vertical orientation axis (concurrent with the vertical orientation axis).

The means for gripping the wheel of the rolling object allow the wheel to be grabbed. For example, these gripping means can comprise a clamp system, a wedging system, magnetic means, adhesive means or any similar system. Advantageously, the gripping means can be movable so as to adapt to any wheel dimension and any wheel track. Motion of the gripping means can be achieved by means of one or more cylinders, for example electric cylinders, screw-nut systems, rack and pinion systems, or any similar means.

The means for lifting the wheel allow the wheel of the rolling object to be elevated, so that this wheel of the rolling object no longer touches the floor, thus facilitating displacement of the rolling object by the electric propulsion system. The mass of the rolling object supported by this wheel is then transferred to the electric propulsion system. This notably provides the adhesion required for the motivity of the motorized wheel of the electric propulsion system. Furthermore, lifting the wheels allows to limit the number of wheels in contact with the floor and thus to limit frictional forces. Lifting can be achieved by means of one or more cylinders, for example electric cylinders, screw-nut systems, rack and pinion systems, or any similar means.

According to an embodiment of the invention, the electric propulsion system can be configured in such a way that the non-motorized wheel(s) are located beneath the rolling object when the electric propulsion system is coupled to the rolling object. Thus, a part of the electric propulsion system does not protrude from the rolling object, which facilitates its use in reduced spaces.

According to an implementation of the invention, the electric propulsion system can be configured in such a way that the motorized wheel is located outside the rolling object, in the longitudinal direction of the frame, when the electric propulsion system is coupled to the rolling object. In other words, the part of the frame supporting the motorized wheel protrudes from the rolling object in the longitudinal direction of the frame, when the electric propulsion system is coupled to the rolling object.

Alternatively, the electric propulsion system can be configured in such a way that the motorized wheel is located beneath the rolling object when the electric propulsion system is coupled to the rolling object. Thus, a part of the electric propulsion system does not protrude from the rolling object, which facilitates its use in reduced spaces.

According to an implementation of the invention, the motorized wheel can be arranged at one longitudinal end of the frame, and the non-motorized wheels can be arranged at the other longitudinal end of the frame.

The frame can be made up of a mechanically welded assembly.

According to a preferred embodiment, the coupling means are connected to the frame between the motorized wheel and the non-motorized wheel(s). Thus, the longitudinal size of the propulsion system is limited.

According to the invention, the handlebar comprises a connection with the frame and/or the driven wheel. Thus, exerting a force on the handlebar can drive and/or steer the frame and/or the driven wheel, and therefore the electric propulsion system.

Furthermore, the connection comprises a means of locking/unlocking the handlebar relative to the frame and/or a driven wheel (or at least one driven wheel) of the electric propulsion system from at least one position, referred to as “locking position”, where the handlebar is attached to the frame and/or to said driven wheel, to a position, referred to as “unlocking position”, enabling at least free motion of the handlebar in a horizontal plane, for example through rotation of the handlebar around a vertical axis, relative to the frame and/or to the driven wheel. Thus, in unlocked position, the system is so configured that an action on the handlebar cannot cause motion of the system. Of course, the locking/unlocking means also allows to shift from unlocking position to locking position.

The locking position of the handlebar allows the electric propulsion system to be moved by means of the handlebar, notably during the phase when the rolling object is coupled to the electric propulsion system, and the unlocking position allows to move only the handlebar (i.e. without driving the frame or the driven wheel) to a position allowing to limit the space required by the system, notably when it is coupled. The handlebar can thus be retracted (or folded away). This specific feature is particularly advantageous for moving the coupled system in restricted environments, as in the case of hospital beds in corridors and/or lifts. Moving the coupled propulsion system can be achieved by directly actuating the rolling object, a hospital bed for example, without requiring the handlebar. Moving (or retracting or folding away) the handlebar allows to position it in different positions enabling adaptation to various situations in restricted environments, motion of the handlebar being independent of the motion of the propulsion system when the locking/unlocking means is in unlocking position.

The unlocking position is possible notably when the system is coupled to the rolling object, because motion of the coupled system can then be achieved by acting directly on the rolling object (the hospital bed for example). The handlebar is then no longer necessary to move the assembly and it can be retracted, notably using the locking/unlocking means.

According to an embodiment, the locking/unlocking means can comprise a single locking position where the handlebar can be attached to the frame.

According to an embodiment, the locking/unlocking means can comprise a single locking position where the handlebar can be attached to the driven wheel (the horizontal axis of the driven wheel for example).

According to a preferred variant, the locking/unlocking means can comprise at least two locking positions. In a first locking position, the handlebar can be attached to the frame, and in a second locking position, the handlebar can be attached to the driven wheel (the horizontal axis of the driven wheel for example).

The first locking position (handlebar attached to the frame) is advantageous for the phase of docking the electric propulsion system and the rolling object in order to position the electric propulsion system close to the rolling object, thus enabling gripping and lifting of at least one wheel of the rolling object. This first locking position can be referred to as “trolley” mode. In this position, the handlebar can for example be inclined with respect to the vertical axis.

The second locking position (handlebar attached to the driven wheel) allows the system to be used in “scooter” mode, i.e. with the user standing on the electric propulsion system. They can for example be positioned on a platform or on the frame. By connecting the handlebar to the driven wheel, the user can directly steer the electric propulsion system. In this second locking position, the handlebar preferably remains substantially vertical. In other words, it is not inclined with respect to the vertical axis.

This variant with at least two locking positions provides several modes of operation of the electric propulsion system, which allows to further improve the adaptation of the system to various situations.

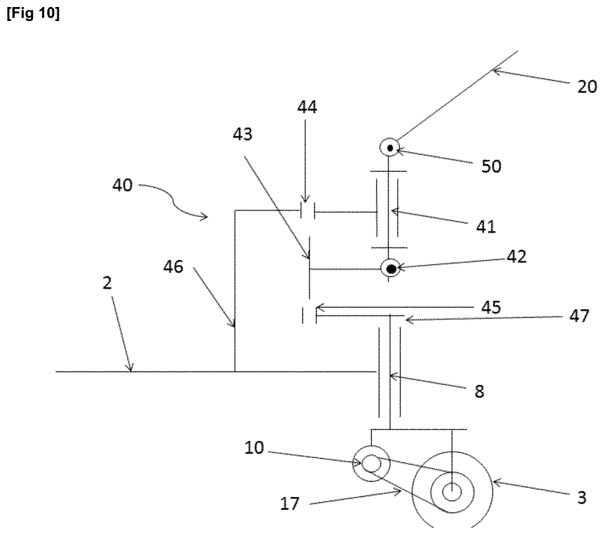

FIGS. 10, 11 and 12 schematically illustrate, by way of non-limitative example, an example of a variant providing two locking positions and one unlocking position.

The electric propulsion system comprises a frame 2 fitted with a wheel 3 driven by an electric machine 10 through the agency of a drive 17 such as a chain or a belt. According to a variant, driven wheel 3 could be directly driven by electric machine 10, without requiring a drive. Driven wheel 3 is attached to a vertical axle 8, pivotally connected to frame 2. Axle 8 is off-centered (offset) with respect to the vertical axle passing through the center of wheel 3. Thus, wheel 3 is an orientable off-centered wheel.

The system also comprises a handlebar 20 connected by a joint 50 (joint 50 can have a horizontal axis for example) to a vertical axle 41, vertical axle 41 being pivotally connected to frame 2 by means of interface piece 46, interface piece 46 being attached to frame 2. Handlebar 20 can thus be inclined to the vertical direction by means of joint 50. Vertical axle 41 connected to handlebar 20 and vertical axle 8 connected to driven wheel 3 are substantially coaxial.

Furthermore, the system comprises a locking/unlocking means 40 providing two locking positions, one allowing handlebar 20 to be attached to frame 2, and the other allowing handlebar 20 to be attached to driven wheel 3, and one unlocking position. Locking/unlocking means 40 notably comprises an interface piece 46. Interface piece 46 comprises a first coupling piece 44.

Locking/unlocking means 40 comprises a dog clutch 42 supporting a connecting piece 43. It also comprises a second coupling piece 45 attached to a piece 47, this piece 47 being itself attached to vertical axle 8 of driven wheel 3.

Dog clutch 42 can be positioned on vertical axle 41, at one end thereof for example.

A dog clutch 42 is a device enabling direct coupling of two mechanical parts through teeth and/or grooves.

Dog clutch 42 has three positions. As shown in FIG. 10, the position of the dog clutch corresponds to the unlocking position, leaving connecting piece 43 free, i.e. not connected to first coupling piece 44 and not connected to second coupling piece 45. In other words, in this position of dog clutch 42, handlebar 20 can be retracted, therefore moved without causing displacement of the electric propulsion system. In this unlocking position, the motion of handlebar 20 is independent of the motion of the electric propulsion system.

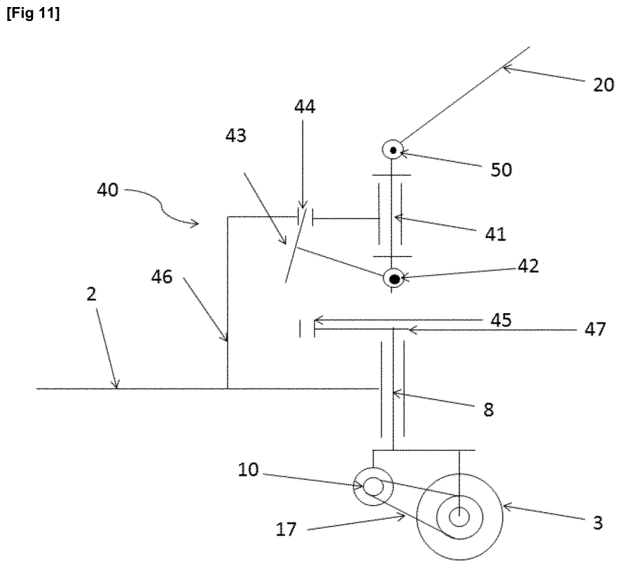

FIG. 11 shows dog clutch 42 in a first locking position. In this case, the position of dog clutch 42 allows connection (locking) of connecting piece 43 to first coupling piece 44 of interface piece 46 attached to frame 2. Thus, in this first locking position, handlebar 20 is attached to frame 2. This position is advantageously used to enable docking of the electric propulsion system and a rolling object.

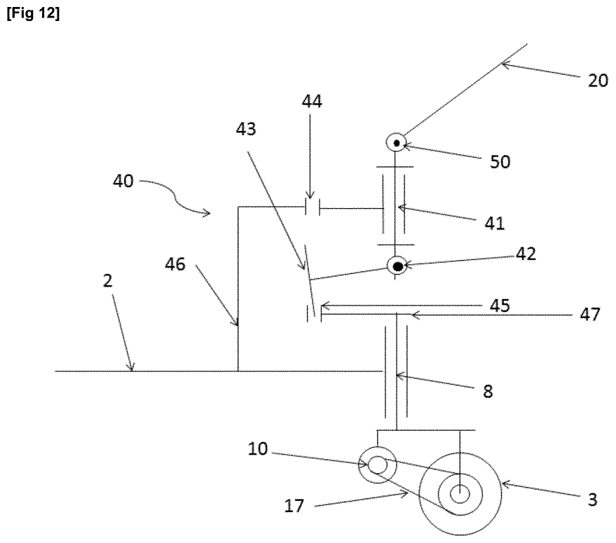

FIG. 12 shows dog clutch 42 in a second locking position. In this case, the position of dog clutch 42 allows connection (locking) of connecting piece 43 to second coupling piece 45 of piece 47 attached to driven wheel 3. Thus, in this second locking position, handlebar 20 is attached to driven wheel 3. This position is advantageously used for the scooter mode, the user can then use handlebar 20 for orienting the wheels of the propulsion system in scooter mode.

In FIGS. 10 to 12, the change in position of dog clutch 42 is shown by a rotation (upward for moving from the position of FIG. 10 to that of FIG. 11 for example, or downward for moving from the position of FIG. 10 to that of FIG. 12 for example) of connecting piece 43 about a horizontal axis of dog clutch 42. The change in position of dog clutch 42 could also be achieved through an upward translation of connecting piece 43 for connection to first coupling piece 44 and/or a downward translation for connection to second coupling piece 45. Of course, motions combining rotations and translations are also possible for the changes in position of dog clutch 42 enabling engagement of connecting piece 43 with first coupling piece 44 or second coupling piece 45.

Dog clutch 42 can for example be actuated in one or the other of the three possible positions by means of a lever (not shown) directly controlled by the user.

By way of non-limitative example, the locking/unlocking means can also be made in different ways. It may be a pin that can move so as to block or unblock two pieces (such as a pull pin).

The locking/unlocking means can also use friction means. When the two pieces are in contact, friction prevents relative motion of the two pieces. When there is sufficient clearance, the pieces can move in relation to one another. A clutch can fulfil this function for example.

The locking/unlocking means can also comprise magnetic elements. When there is a magnetic field, relative motion of the two pieces is impossible. When the magnetic field is inoperative, the pieces can move in relation to one another.

According to a configuration of the system according to the invention, the locking/unlocking means can comprise a first axle. This first axle (vertical for example) can notably be used for rotation about this first axle (the first axle then serves as the rotation axis), rotation of the handlebar about the first axle for example.

Alternatively or additionally, the first axle can be used for translation along this first axle (the first axle can then be a slideway), translation of the handlebar along the first axle for example.

According to a variant, the first axle can then be attached to the frame and/or to the driven wheel. When the system is in unlocked position, the handlebar can rotate freely about the first axle and/or move freely along the first axle, thus enabling motion of the handlebar independently of the frame and/or the driven wheel. In locked position, by preventing relative translation and rotation of the first axle and the handlebar, by means of a pin that would be positioned in the first axle byway of non-limitative example, motion of the handlebar would cause motion of the frame and/or of the driven wheel.

According to an alternative, on the other hand, the first axle can be attached to the handlebar. In this case, the unlocked position would enable relative rotation of the first axle with respect to the frame and/or the driven wheel, and the locked position, for example through a pin positioned in the axle, would provide a rigid connection between the first axle and the frame and/or the driven wheel.

Preferably, the first axle can be vertical (when the propulsion system rests on a flat and even floor), which can simplify the handlebar displacement kinematics for retracting it, notably on the side of the system (i.e. close to a transverse end of the system and/or of the rolling object), and limit the overall size of the system.

Advantageously, the coupling means can comprise means for orienting at least one wheel of the rolling object, referred to as gripped (by the gripping means) wheel, in a direction forming a non-zero angle with the longitudinal direction of the frame of the propulsion system; for example, the angle between the orientation of the gripped wheel and the longitudinal direction of the frame can be at least 10°. By orienting the wheel of the rolling object in a direction forming a non-zero angle with the longitudinal direction, the rolling object is maintained in longitudinal position relative to the propulsion system. In other words, a relative longitudinal motion between the coupled rolling object and the propulsion system is prevented. Preferably, the coupling means can comprise means for orienting the gripped wheel in a direction substantially perpendicular to the longitudinal direction of the frame of the propulsion system (in other words, the wheel of the rolling object is positioned in a direction parallel to or substantially parallel to the lateral direction of the frame). The longitudinal direction of the frame can correspond to the direction connecting the motorized wheel to the non-motorized wheel. The longitudinal direction corresponds to the principal direction of displacement of the electric propulsion system. A substantially perpendicular direction is understood to be a direction forming an angle ranging between 80° and 100° relative to the longitudinal direction. Thus, upon propulsion of the rolling object, at least one wheel of the rolling object is gripped, lifted and oriented in a different direction to the longitudinal direction of the frame (for example with an angle greater than 10° between the orientation of the gripped wheel and the longitudinal direction of the frame), preferably substantially perpendicular to the longitudinal direction of the frame. By orienting at least one wheel of the rolling object in a different direction to the longitudinal direction of the frame, the angle thus formed being preferably greater than 10°, more preferably close to 90°, the stability of the coupled assembly made up of the rolling object on the propulsion system is improved. In addition, the coupling means thus act on the least thick side of the wheels of the rolling object. This contributes to ensuring that the coupling means have reduced lateral dimensions in relation to the lateral dimensions of the propulsion systems of the prior art (as described for example in patent applications WO-2012/171,079 and WO-2013/156,030), which facilitates their use in reduced spaces such as corridors and lifts. The means of orienting the wheel of the rolling object can be implemented through the displacement of the wheel gripping means. According to an implementation of the invention, the electric propulsion system can perform the following sequence of steps for coupling: orienting the wheel of the rolling object in a different direction to the longitudinal direction of the frame, gripping the wheel of the rolling object and lifting the wheel of the rolling object.

According to an aspect of the invention, the system can comprise a means for controlling the locking/unlocking means. This control means can be mechanical (a cable and/or a spring for example) and/or electrical (via an electric cable and an electric control box).

For example, at least one of the locking or unlocking actions can be automatic or semi-automatic. For example, in an automatic solution, a pin can be armed (by a spring for example) to allow automatic locking in an orifice when the pin is opposite the orifice. Other solutions could allow automatic unlocking.

A pre-armed solution, i.e. ready to be automatically locked (or unlocked) by a pin armed with a spring for example is advantageous for a semi-automatic solution. Indeed, this pre-armed solution can be used with a locking control means (a lever for example). By actuating this locking control means, the pre-armed solution is activated (the spring is compressed for example). The handlebar can then be handled (rotation for example) until the pin faces the orifice provided. When the pin faces the orifice, the initially compressed spring is released and causes the pin to move into the orifice. Thus, locking is achieved. Other solutions could allow semi-automatic unlocking.

When locking is automatic or semi-automatic, unlocking can then be controlled by the control means, whether a mechanical system such as a cable for example or an electric system. For example, the user can activate the control means to unlock the system. The control means can be electrically or mechanically connected, by a cable, among others, to the locking/unlocking means. Similarly, when unlocking is automatic or semi-automatic, locking can be controlled by the control means.

An automatic or semi-automatic locking (or unlocking) action can notably be provided on a locking/unlocking means such as a dog clutch.

The user can also control both locking and unlocking using the control means. The control means can for example comprise an electric box, or an electric or mechanical actuator.

According to a variant embodiment, when the propulsion system is coupled to the rolling object, control of the propulsion system is not necessarily achieved through the handlebar, control of the displacement and of the direction of displacement of the coupled system can be achieved using means of controlling the rolling object, a handle, a handlebar or any similar device of the rolling object for example.

According to an implementation of the invention, the handlebar can come in form of an arm that may be articulated, i.e. an arm consisting of several elements linked to one another. In order to favour retraction of the handlebar, the links between the constituent elements of the handlebar can move from a rigid link to an articulated link, by locking/unlocking or blocking/unblocking. Various embodiments of this implementation are described in the rest of the description.

According to an implementation of the system according to the invention, the handlebar can notably consist of a connecting piece and a rod. Additionally, the connecting piece can comprise the locking/unlocking means and the rod can be articulated relative to the connecting piece around a first horizontal axle. Therefore, the handlebar has an additional joint, this pivot connection providing an additional degree of freedom for retraction of the system. The connecting piece and the rod forming the handlebar can be rigidly attached to one another in locked position. The connecting piece can be attached to the frame and/or to the driven wheel by the locking/unlocking means of the handlebar. Thus, the handlebar can be moved to a position allowing easiest possible operation, notably while using the coupled system. Furthermore, the handlebar can be moved, during operation, according to space constraints, without the need for removing the handlebar. Indeed, a removable handlebar is not necessarily convenient because, in this case, the handlebar needs to be stored elsewhere, with the risk of forgetting it, or carried, which might cause musculoskeletal disorders.

In unlocking position, the connecting piece can for example rotate around the first axle, itself attached to the frame and/or to the driven wheel. The connecting piece can then comprise a tubular zone surrounding the first axle.

Advantageously, the handlebar can further comprise an operating piece and a blocking/unblocking means, the blocking/unblocking means connecting the operating piece and the rod.

The operating piece can notably be T-shaped, the vertical bar of the T can then be connected to the rod by the blocking/unblocking means, and the horizontal bar of the T can then serve as a bar for operating the system, substantially in the manner of a bicycle handlebar.

The blocking/unblocking means allows, in a blocking (or locking) position, to rigidly attach the operating piece to the rod enabling motion of the propulsion system by means of the handlebar and, in an unblocking (or unlocking) position, to enable relative motion of the operating piece with respect to the rod. Preferably, in unblocked position, relative rotation of the operating piece with respect to the rod around an axle (a horizontal axle for example) connecting these two pieces can be achieved, said axle being then positioned at one end of the rod and at the end of the vertical bar of the T remote from the junction of the vertical bar of the T and the horizontal bar of the T. Thus, the handlebar has an additional joint providing an additional degree of freedom for retracting the handlebar when it is no longer necessary to the user for steering the electric propulsion system or when it needs to be moved for available space reasons.

The pivot connection between the rod and the operating piece around the (horizontal or vertical for example) axle is advantageous because it can for example be used to position the operating piece (the horizontal bar of the T for example) along (i.e. in the longitudinal direction) one (transverse) end of the rolling object, notably the bed. In other words, the operating piece is positioned alongside one end of the rolling object. Thus, the retracted handlebar occupies a reduced space and the operating piece is in a position that does not really hinder operation of the system, notably when it is coupled.

The blocking/unblocking means allows the connection between the rod and the operating piece to shift from a blocking position to an unblocking position (and vice versa).

The blocking/unblocking means can be equivalent or substantially equivalent to the locking/unlocking means. In other words, by way of non-limitative example, the blocking/unblocking means can comprise a pin moving in an orifice, a friction system such as a clutch and/or a magnetic system.

The blocking/unblocking control can be activated by an action of the user, for example a mechanical actuator, a pull pin or via a cable, or an electrical means.

Blocking and/or unblocking can also be automatic or semi-automatic, like locking and/or unlocking of the locking/unlocking means, for example by means of an armed pin to allow automatic insertion in an orifice when the orifice is opposite the pin. The pin can for example be armed with a spring.

Advantageously, a control means can control the locking/unlocking means and the blocking/unblocking means. The system is thus simplified. The user can control locking and/or unlocking of the locking/unlocking means and of the blocking/unblocking means using a single control means. In addition, this control can be performed simultaneously. Indeed, unblocking and unlocking are necessary to retract the handlebar. It is therefore advisable to operate them together, which simplifies the procedure and saves time. Similarly, blocking and locking allow the electric propulsion system to be driven by the handlebar. It is thus also advisable to operate them together, which simplifies the handlebar positioning procedure and saves time.

According to an embodiment of the system of the invention, the handlebar can comprise a control panel. The control panel allows the user to control the system, for example to drive locking and/or unlocking of the locking/unlocking means and/or blocking and/or unblocking of the blocking/unblocking means. In other words, the steering data input by the user via the control panel is transmitted to the control means so as to actuate the actuators (locking/unlocking means, blocking/unblocking means, among others). Preferably, the control panel is positioned at the highest end of the handlebar (i.e. the end that does not correspond to that connected to the frame or the driven wheel). For example, preferably, the control panel is positioned on the operating piece. Thus, the position of the control panel is ideal for the user, as the control panel remains easily accessible. Musculoskeletal disorders related to control of the system are thus limited. It is notably convenient for the control panel to be placed at a suitable height and easily accessible so as to allow the emergency stop control of the system to be used, a control that can be provided on the control panel.

The control panel can also be used to control the electric machine and/or the coupling means. For control of the electric machine, turning the electric assistance on and off, adjusting the speed and/or the torque thereof, can for example be controlled. Control of the coupling means can for example be achieved by controlling the gripping means for gripping the wheel or the wheels of the rolling object, the means for lifting the wheel or the wheels of the rolling object, and preferably the means for orienting the wheels of the rolling object. These controls can consist in moving constituent elements of the coupling means.

The invention also relates to a method for retracting the handlebar of the system described above. What is understood by retracting (or folding away) the handlebar is to move it to a more convenient location as regards the overall size of the system, notably when it is coupled to a rolling object, without causing motion of the electric propulsion system. The retracted handlebar remains positioned on the electric propulsion system. In other words, the handlebar is not removable and it can be moved independently of the removable propulsion system. For this method, at least the following steps are carried out:
unlocking the locking/unlocking means, the handlebar can then freely move relative to the frame and/or the driven wheel. For example, the handlebar can at least move through a free rotation and/or a free translation relative to the frame and/or the driven wheel. Thus, in unlocked position, the handlebar can be handled and positioned in a place that does not impact the space required for the system (or as little as possible), this handling of the handlebar causing no orientation and/or displacement of the frame or the driven wheel,
moving the handlebar to a suitable position for moving the propulsion system, notably when it is coupled to a rolling object, in a reduced space. Furthermore, when moving the system, the handlebar can be moved simultaneously with and independently of the motion of the system. Indeed, when moving the system, the reduced space can evolve and, therefore, being able to change the position of the handlebar while handling the system is an additional asset.

Preferably, the method for retracting the handlebar can be notably implemented after coupling the rolling object to the removable electric propulsion system. Indeed, the propulsion system has a larger overall size when it is coupled to a rolling object. It is therefore particularly interesting to be able to limit the size thereof when it is coupled.

Advantageously, for the embodiment wherein the handlebar comprises a means of blocking/unblocking an operating means (the operating piece for example), the blocking/unblocking means can be unblocked. Thus, the space required for the handlebar is even more reduced. Preferably, unblocking the blocking/unblocking means can be done simultaneously with unlocking of the locking/unlocking means. Indeed, the purpose of unblocking and unlocking is to retract the handlebar so as to limit as much as possible the space occupied by the handlebar and, therefore, by the electric propulsion system. It is thus possible to actuate (or control or drive) them simultaneously. Furthermore, through a simultaneous action, the time is reduced, which allows to limit the intervention time and to simplify handling of the system by the user.

Preferably, for the embodiment wherein the handlebar comprises an operating means, after moving the handlebar, for example on one side of the system (a side is understood to be a transverse end of the system) along one side of the bed notably, the operating piece can be pivoted. By pivoting the operating piece with respect to the rod, around a horizontal or vertical axle for example, this rotation being made possible notably by unblocking the blocking/unblocking means of the system, the operating piece can be positioned in such a way that the space occupied by the system is further reduced. The operating piece can notably be positioned along a transverse end of the rolling object (a bed for example), the horizontal bar of the T being then substantially oriented in the longitudinal direction.

The invention also relates to a method for steering the removable electric propulsion system by means of the handlebar. In other words, for this method, the electric propulsion system is driven and controlled by the handlebar. This embodiment is particularly useful when the electric propulsion system is not coupled to a rolling object. Indeed, when it is not coupled, the user cannot use the rolling object for orienting and steering the electric propulsion system. For this method, at least the following steps are carried out:
connecting (or locking) the handlebar to the frame and/or the driven wheel, for example by moving the locking/unlocking means to the locking position. The handlebar is then rigidly attached to the frame and/or to the driven wheel. Preferably, this connection through locking can be done automatically or semi-automatically, for example, by way of non-limitative example, by means of an armed pin ready to engage into an orifice. Thus, the use of the system is simplified and the user just needs to control the unlocking actions,
acting on the handlebar to move and/or orient the removable electric propulsion system. Indeed, once in locking position, an action on the handlebar generates a direct action on the frame and/or on the driven wheel, which allows the electric propulsion system to be driven and steered.

According to a configuration of the method for steering the system according to an embodiment of the invention, wherein the handlebar comprises a connecting piece and a rod, the operating piece can be blocked relative to the rod by the blocking/unblocking means. Thus, the connection between the operating piece and the rod, in blocking position, is a rigid connection. Thus, the actions performed by the user on the operating piece are transmitted to the rod and, therefore, to the electric propulsion system. Preferably, blocking the operating piece with the rod can be achieved simultaneously with locking of the handlebar to the frame and/or to the driven wheel by means of the locking/unlocking means. Thus, the operations related to the use of the system are simplified and of shorter duration. For example, blocking and locking can be controlled by the control means that can receive information from a control panel in which the user stores the blocking/locking action. Alternatively, mechanical locking of the blocking/unblocking means or of the locking/unlocking means can cause locking of the other means, and this can be driven by a cable.

The invention further relates to a coupled assembly comprising a rolling object, such as a rolling bed, and a propulsion system according to any one of the above variant combinations. The rolling object is coupled to the propulsion system by the coupling means. In other words, at least one wheel of the rolling object is gripped, preferably oriented at a non-zero angle to the longitudinal direction of the frame (preferably substantially perpendicular to the longitudinal direction of the frame), and lifted by the coupling means of the propulsion system.

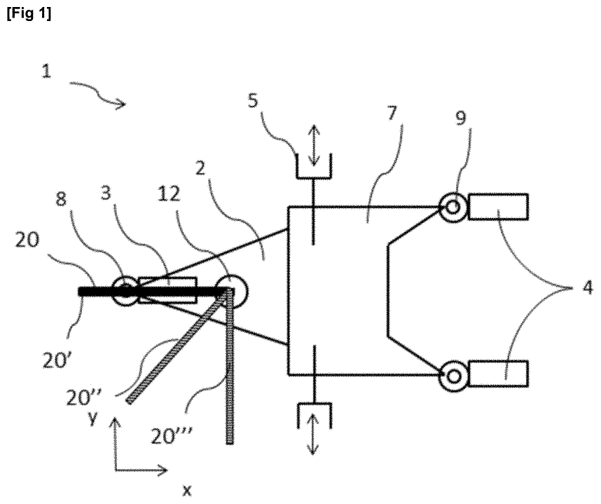

FIG. 1 schematically illustrates, by way of non-limitative example, an electric propulsion system 1 according to an embodiment of the invention. FIG. 1 is a top view of electric propulsion system 1. Electric propulsion system 1 comprises a frame 2. Axis x corresponds to the longitudinal axis of frame 2 and to the principal direction of displacement of propulsion system 1, and axis y corresponds to the lateral axis of frame 2 (axis z, not shown, is vertical). Frame 2 supports three wheels (alternatively, frame 2 can comprise four wheels). Frame 2 supports a wheel 3 (alternatively, frame 2 can support two wheels 3), which is a wheel driven by an electric machine (not shown). Wheel 3 is orientable relative to frame 2, around a vertical axle 8. At the other end, frame 2 supports two wheels 4, which are not driven by an electric machine. Wheels 4 are orientable relative to the frame around vertical axles 9. Electric propulsion system 1 further comprises coupling means 5. According to the embodiment illustrated, electric propulsion system 1 comprises two coupling means 5 on either side of the frame in the lateral direction (axis y) so as to provide coupling by means of two wheels of the rolling object (not shown). Coupling means 5 are shown in a simplified manner as clamps. The lateral motion of the coupling means is shown by a double arrow. This lateral motion can serve for gripping and orienting the wheels of the rolling object. Coupling means 5 are arranged, in direction x, between motorized wheel 3 and non-motorized wheels 4.

Furthermore, electric propulsion system 1 comprises a handlebar 20, for example in form of a stem equipped with a handle (not shown), and a connection with frame 2 through a locking/unlocking means 12, allowing handlebar 20 to be attached to the frame and/or to driven wheel 3 or, on the other hand, allowing handlebar 20 to freely move with at least one degree of freedom (a rotation or a translation for example) relative to frame 2 and/or driven wheel 3.

In FIG. 1, the locking/unlocking means is in unlocking position, in other words, handlebar 20 is not rigidly attached to frame 2 or to driven wheel 3. Since the locking/unlocking means is unlocked, it is possible to move handlebar 20 independently of frame 2 or driven wheel 3, for example, a rotation of handlebar 20 around an axle connected to frame 2 (or driven wheel 3) can be performed, and the axle may be vertical or substantially vertical.

FIG. 1 shows three positions 20′, 20″ and 20′″ of the handlebar in top view, relative to frame 2, these positions being made possible by the unlocking position. In position 20′, in top view, handlebar 20 extends substantially in the longitudinal direction (x). In position 20′″, in top view, handlebar 20 extends substantially transversely (y). This position 20′″ is also referred to as “side position” or “on the side”. Handlebar 20 is then described as “on the side”. Position 20″ is an intermediate position allowing to shift from longitudinal position 20′ to side position 20′″, and vice versa.

Besides, electric propulsion system 1 comprises a supporting platform 7 (for a user for example). Platform 7 is arranged at the end of frame 2 supporting non-motorized wheels 4.

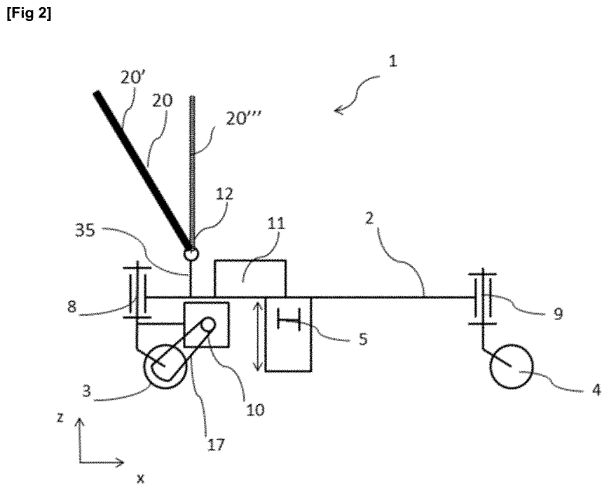

FIG. 2 schematically illustrates, by way of non-limitative example, an electric propulsion system 1 according to a first variant embodiment of the invention. FIG. 2 is a side view of electric propulsion system 1. Electric propulsion system 1 comprises a frame 2. Axis x corresponds to the longitudinal axis of frame 2 and to the principal direction of displacement of the propulsion system, and axis z corresponds to the vertical axis of frame 2, axis y (not shown) corresponds to the transverse axis. Frame 2 supports three wheels. Frame 2 supports a wheel 3, which is driven by an electric machine 10 by means of a drive 17 such as a belt or a chain for example (alternatively, electric machine 10 can be directly connected to wheel 3). Wheel 3 is orientable relative to frame 2, around a vertical axle 8. Electric machine 10 can interact with pivot 8 of motorized wheel 3. At the other end, frame 2 supports two wheels 4, which are two wheels that are not driven by an electric machine. Wheels 4 are orientable relative to frame 2 around vertical axles 9. Electric propulsion system 1 further comprises coupling means 5. According to the embodiment illustrated, electric propulsion system 1 comprises two coupling means 5, on either side of frame 2 in the lateral direction (axis y) so as to provide coupling by means of two wheels of the rolling object (not shown). Coupling means 5 are shown in a simplified manner as clamps. The vertical motion of coupling means 5 is shown by a double arrow. This vertical motion of the coupling means notably allows lifting of the rolling object wheels. Coupling means 5 are arranged, in direction x, between motorized wheel 3 and non-motorized wheels 4.

Furthermore, electric propulsion system 1 comprises a handlebar 20, for example in form of a stem equipped with a handle (not shown) connected to frame 2 by a joint comprising a locking/unlocking means 12. This locking/unlocking means 12 allows handlebar 20 to be attached to a vertical axle 35, vertical axle 35 being rigidly attached to the frame (alternatively, this vertical axle 35 could be attached to the horizontal axle of driven wheel 3). Handlebar 20 is shown in a first position 20′ corresponding to that of FIG. 1, shown in top view, and in a position 20′″ corresponding to that of FIG. 1 in top view. To enable this change in position of the handlebar relative to the frame, locking/unlocking means 12 is in unlocking position.

Besides, electric propulsion system 1 comprises a battery 11. Battery 11 is arranged on frame 2 close to electric machine 10 and motorized wheel 3.

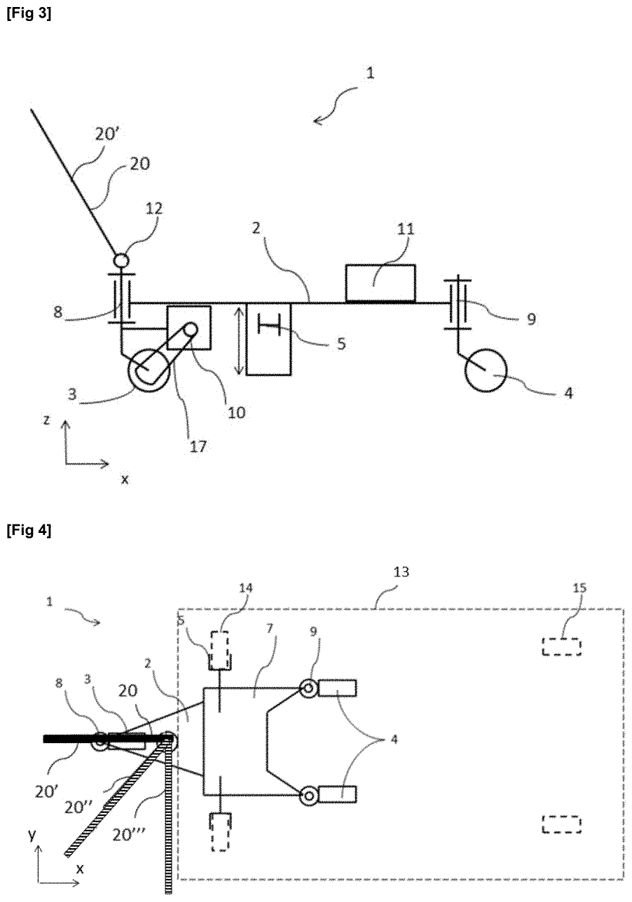

FIG. 3 schematically illustrates, by way of non-limitative example, an electric propulsion system 1 according to a second variant embodiment of the invention. FIG. 3 is a side view of electric propulsion system 1. Electric propulsion system 1 comprises a frame 2. Axis x corresponds to the longitudinal axis of frame 2 and to the principal direction of displacement of the propulsion system, and axis z corresponds to the vertical axis of frame 2. Frame 2 supports three wheels. Frame 2 supports a wheel 3, which is driven by an electric machine 10 by means of a drive 17 such as a belt or a chain for example. Wheel 3 is orientable relative to frame 2, around a vertical axle 8. Electric machine 10 can interact with pivot 8 of motorized wheel 3. At the other end, frame 2 supports two wheels 4, which are two wheels that are not driven by an electric machine. Wheels 4 are orientable relative to the frame around vertical axles 9. Electric propulsion system 1 further comprises coupling means 5. According to the embodiment illustrated, electric propulsion system 1 comprises two coupling means 5, on either side of the frame in the lateral direction (axis y) so as to provide coupling by means of two wheels of the rolling object (not shown). Coupling means 5 are shown in a simplified manner as clamps. The vertical motion of coupling means 5 is shown by a double arrow. This vertical motion of the coupling means notably allows lifting of the rolling object wheels. Coupling means 5 are arranged, in direction x, between motorized wheel 3 and non-motorized wheels 4.

Furthermore, electric propulsion system 1 comprises a handlebar 20, for example in form of a stem equipped with a handle (not shown) connected to vertically oriented axle 8 of motorized wheel 3 by means of a connection comprising a locking/unlocking means 12. Handlebar 20 is shown in position 20′, i.e. the position referred to as “longitudinal”. In this position 20′, it is possible to lock locking/unlocking means 12 so as to move and orient frame 2 and driven wheel 3 by means of handlebar 20. In locking position, handlebar 20 is indeed rigidly attached to vertical axle 8, itself rigidly attached to the horizontal axle of driven wheel 3.

Besides, electric propulsion system 1 comprises a battery 11. Battery 11 is arranged on frame 2 close to non-motorized wheels 4.

FIG. 4 schematically illustrates, by way of non-limitative example, an electric propulsion system 1 according to an embodiment of the invention, coupled to a rolling object 13. FIG. 4 is a top view of electric propulsion system 1 and of rolling object 13. The embodiment of FIG. 4 corresponds to the embodiment of FIG. 1. Rolling object 13 can be of any type, notably a rolling bed. The rolling object comprises two wheels 14, arbitrarily referred to as rear wheels, and two wheels 15, arbitrarily referred to as front wheels. Electric propulsion system 1 comprises a frame 2. Axis x corresponds to the longitudinal axis of frame 2 and to the principal direction of displacement of the propulsion system, and axis y corresponds to the lateral axis of frame 2. The frame supports three wheels. Frame 2 supports a wheel 3, which is a wheel driven by an electric machine (not shown). Wheel 3 is orientable with respect to frame 2, around a vertical axle 8. At the other end, frame 2 supports two wheels 4, which are two wheels that are not driven by an electric machine. Wheels 4 are orientable with respect to the frame around vertical axles 9. Electric propulsion system 1 further comprises coupling means 5. According to the embodiment illustrated, electric propulsion system 1 comprises two coupling means 5 on either side of the frame in the lateral direction (axis y) in order to achieve coupling by means of two rear wheels 14 of the rolling object. Coupling means 5 are shown in a simplified manner as clamps. Rear wheels 14 of the rolling object are arranged in the clamps, and they are substantially oriented along axis y, i.e. an axis perpendicular to the longitudinal axis (axis x) of frame 2. Furthermore, front wheels 15 of the rolling object are free and not coupled.

Electric propulsion system 1 also comprises a handlebar 20, for example in form of a stem equipped with a handle (not shown) articulated with respect to frame 2. Handlebar 20 is connected to frame 2 by a joint comprising a locking/unlocking means. Positions 20′, 20″ and 20′″ are three possible positions of handlebar 20 when the locking/unlocking means is in unlocked position, thus allowing motion (notably rotation) of handlebar 20 independently of frame 2. Position 20′ corresponds to a position where, in top view, handlebar 20 extends substantially in the longitudinal direction, whereas position 20′″ corresponds to a position where, in top view, handlebar 20 extends substantially in the transverse direction, handlebar 20 is then positioned on the side in position 20′″. This position 20′″ can allow handlebar 20 to be retracted on the side. Indeed, in position 20′″, in top view, handlebar 20 is positioned alongside one end of rolling object 13, shown in dotted line, the bed head for example. Position 20″ is an intermediate position allowing to shift from longitudinal position 20′ to side position 20′″, and vice versa.

When the handlebar is on the side in position 20′″, the handlebar, in top view, is oriented in a direction substantially perpendicular to the longitudinal direction. In other words, it is oriented in a transverse (or lateral) direction. In this side position 20′″, the handlebar protrudes, in the transverse direction, on the side of rolling object 13.

Besides, electric propulsion system 1 comprises a supporting platform 7 (for supporting a user for example). Platform 7 is arranged at the end of frame 2 supporting non-motorized wheels 4. For the embodiment of FIG. 4, coupling means 5, non-motorized wheels 4, platform 7 and a major part of frame 2 are located beneath the rolling object. Only motorized wheel 3 and handlebar 20 can protrude from rolling object 13 in the longitudinal direction x of frame 2.

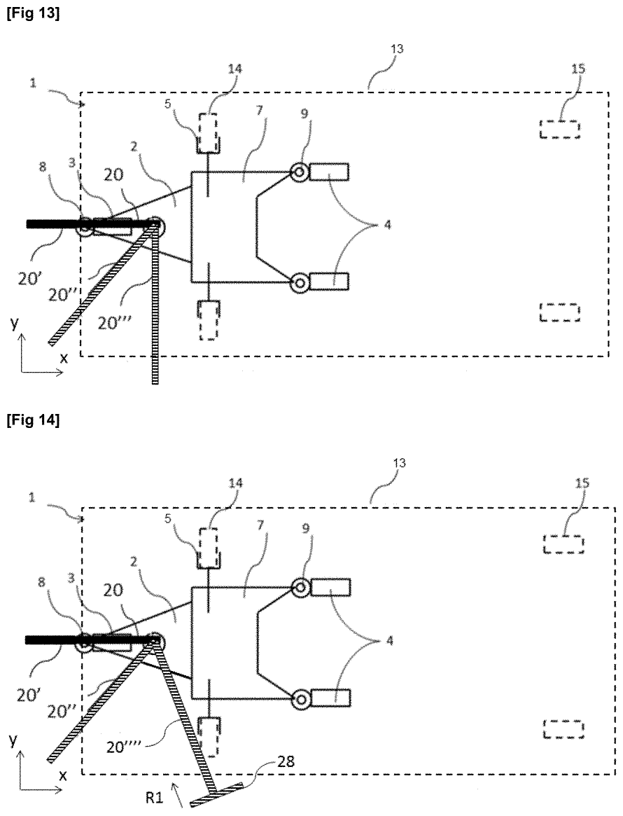

FIGS. 13 to 15 schematically show, by way of non-limitative example, variants of the propulsion system coupled to the rolling object, in top view. References identical to those of FIG. 4 correspond to the same elements and are therefore not detailed any further hereafter.

In FIGS. 13 to 15, once coupled to rolling object 13, electric propulsion system 1 is essentially positioned beneath rolling object 13. In other words, the major part of electric propulsion system 1 is beneath rolling object 13, after being coupled thereto. Only part of the handlebar protrudes from the space occupied in the longitudinal direction (in positions 20′ and 20″) and/or in the transverse direction (in position 20′″). Once coupled, motorized wheel 3 is positioned beneath rolling object 13.

In FIG. 13, the handlebar being in side position 20′″, the handlebar protrudes from a transverse end of rolling object 13. It therefore protrudes on the side of the rolling object, the protrusion being limited to a small part of the handlebar. The handlebar can comprise an operating piece (not shown). When it is used, this operating piece can notably have a substantially longitudinal principal direction in position 20′″ so as to be positioned along the side of rolling object 13 (the side being a transverse end of rolling object 13).

In FIG. 14, the handlebar can also be in a position 20′″ forming an angle greater than 90° to the direction of longitudinal position 20′ of the handlebar. According to the length of the handlebar and the transverse length of the rolling object, by allowing a rotation of the handlebar greater than 90° with respect to position 20′″, protrusion of the handlebar on the side of the rolling object can be limited.

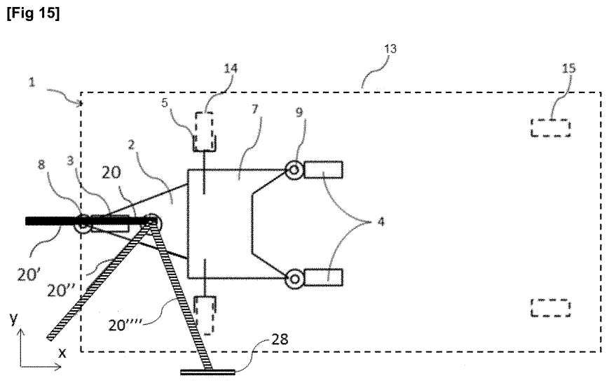

The handlebar comprises an operating piece 28. This operating piece 28 notably has a substantially horizontal part (a horizontal or substantially horizontal bar for example) on which the user can put their hands to drive and steer the propulsion system. Operating piece 28 can rotate in the horizontal plane (around a vertical axis for example), according to rotation R1, so as to be positioned in the longitudinal direction, along a transverse end of rolling object 13, as shown in FIG. 15. The transverse end corresponds to a side of rolling object 13 that can be, for example, the edge of a bed.

When operating piece 28 is positioned alongside rolling object 13 as in FIG. 15, the transverse dimension of electric propulsion system 1 coupled to rolling object 13 is limited, notably in comparison to the transverse dimension of FIG. 14. The joint between the handlebar and the operating piece thus allows to reduce the space required.

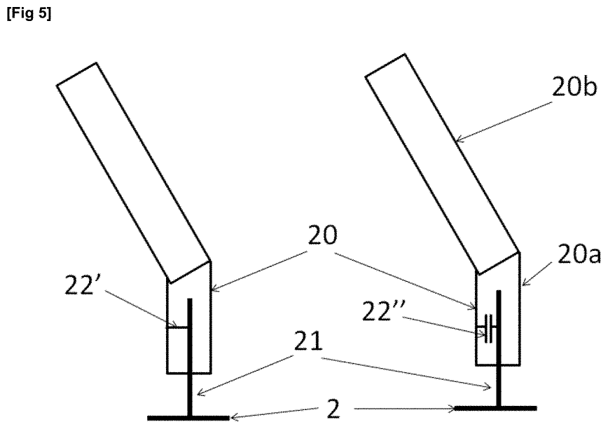

FIG. 5 schematically illustrates, by way of non-limitative example, a first embodiment of a connection of the handlebar to the frame of a system according to the invention.

In this figure, a substantially vertical axle 21 is attached to frame 2.

This axle 21 is connected to handlebar 20 by means of a locking/unlocking means. The locking/unlocking means is shown in locking position 22′ in the left-hand diagram and in unlocking position 22″ in the right-hand diagram. Thus, in the left-hand diagram, when the locking/unlocking means is locked, handlebar 20 is rigidly attached to axle 21 and therefore to frame 2.

On the other hand, in the right-hand diagram, the locking/unlocking means is unlocked and thus allows relative rotation of handlebar 20 around axle 21. In other words, in unlocking position, the connection between handlebar 20 and axle 21 is a pivot connection or a sliding pivot connection.

For this example, handlebar 20 has a first tubular part 20a, this first tubular part 20a being coaxial with axle 21, thus allowing the pivot connection in unlocking position. Handlebar 20 also has an inclined part 20b, which facilitates handling of the electric propulsion system in locking position. First tubular part 20a and inclined part 20b can be rigidly attached to one another or connected by a joint so as to improve the retraction ability in unlocking position.

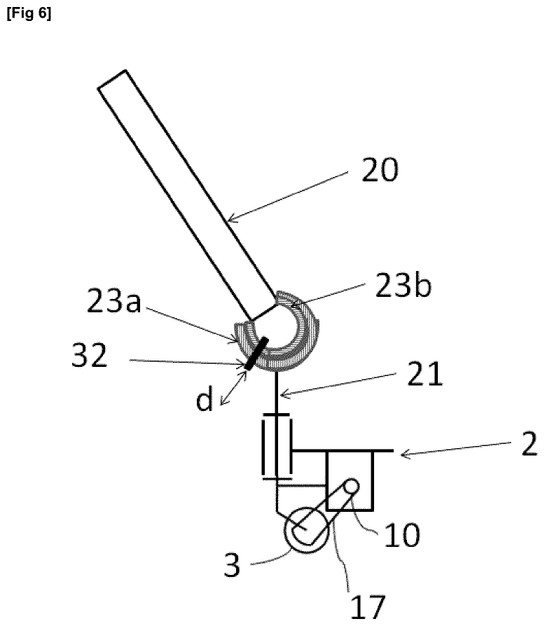

FIG. 6 schematically illustrates, by way of non-limitative example, an embodiment of a connection of the handlebar to the driven wheel of a system according to the invention.

In this figure, a substantially vertical axle 21 is attached to a wheel 3. Wheel 3 is driven by an electric machine 10 through a drive 17 such as a chain or a belt. Axle 21 is in pivot connection relative to frame 2.

This axle 21 is connected to handlebar 20 through a locking/unlocking means, materialized in a simplified and non-limitative manner by a pin 32, shown in locked position in the figure. This pin 32 can move in direction d so as to enable unlocking or, on the contrary, to shift from the unlocking position to the locking position. The connection between handlebar 20 and axle 21 is represented here by a ball joint consisting of a spherical inner piece 23b and a spherical outer piece 23a. Inner piece 23b is housed in outer piece 23a so as to form a ball joint. Inner piece 23b is attached to handlebar 20; outer piece 23a is attached to axle 21. In locking position as shown in FIG. 6, pin 32 prevents relative rotation of inner piece 23b with respect to outer piece 23a.

Axle 21 is attached to wheel 3, for example by the horizontal axle of wheel 3. Thus, in locking position, an action on handlebar 20 is transmitted to wheel 3. The user can then use the handlebar to move the electric propulsion system.

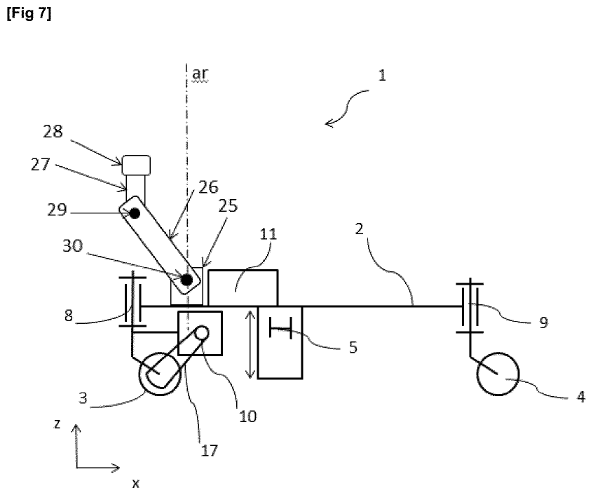

FIGS. 7, 8 and 9 correspond to side views of an electric propulsion system 1 according to the invention for three positions substantially corresponding to positions 20′, 20″ and 20′″ of FIGS. 1 and 4 respectively.

In these three figures, the references corresponding to those of the previous figures correspond to the same elements and are not described again here.

In these figures, the handlebar consists of several elements, notably a connecting piece 25, a rod 26 and an operating piece 28.

Connecting piece 25 can notably comprise a locking/unlocking means for connecting the handlebar to the frame, such as a pin, potentially armed so as to lock automatically, or a clutch or other friction elements or, by way of non-limitative example, an electrically-controlled connection.

Connecting piece 25 is connected to rod 26, at one end of rod 26, by a pivot connection around a first substantially horizontal axle 30.

The other end of rod 26 is connected to operating piece 28 by a blocking/unblocking means, which can have the same operating mode as the locking/unlocking means. In other words, the blocking/unblocking means can comprise a pin that can possibly arm automatically (with a spring for example), a clutch or an electric connection. In blocking position, operating piece 28 is fixedly attached to rod 26: no relative motion between these two pieces is then possible.

In unblocking position, operating piece 28 can freely rotate relative to rod 26 around a second horizontal axle 29.

Operating piece 28 is substantially T-shaped, with a straight portion referred to as vertical bar of the T, corresponding to part 27, and a substantially horizontal bar, this horizontal bar serving as a handle for the user. One end of vertical bar 27 of the T is connected to rod 26 by the blocking/unblocking means.

The axis in dash-dotted line ar corresponds to the vertical axis passing through the axle of connecting piece 25.

In FIG. 7, the handlebar is substantially in position 20′ shown in top view in FIG. 1. Thus, the horizontal bar of the operating piece extends in the transverse axis, perpendicular to the plane of the figure. Axles 29 and 30 also extend along the transverse axis. This position 20′ can enable handling of electric propulsion system 1 by means of the handlebar, notably through operating piece 28.

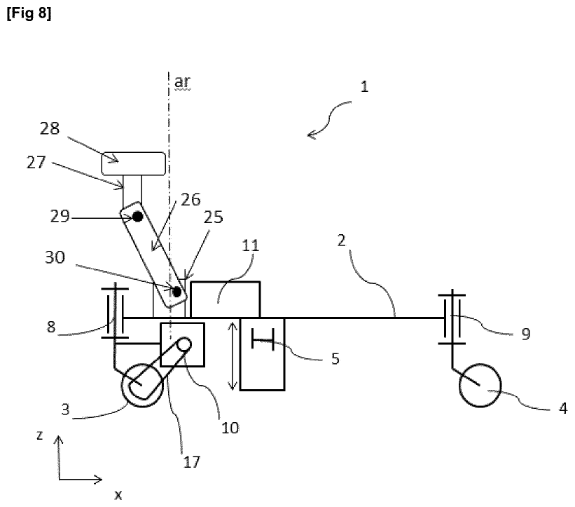

In FIG. 8, the handlebar is in the position substantially corresponding to position 20″ of FIG. 1 in top view. Thus, the horizontal bar of operating piece 28 extends in a direction forming a non-zero angle with the longitudinal direction and with the transverse direction. Axles 29 and 30 substantially extend in the same direction as the horizontal bar of operating piece 28.

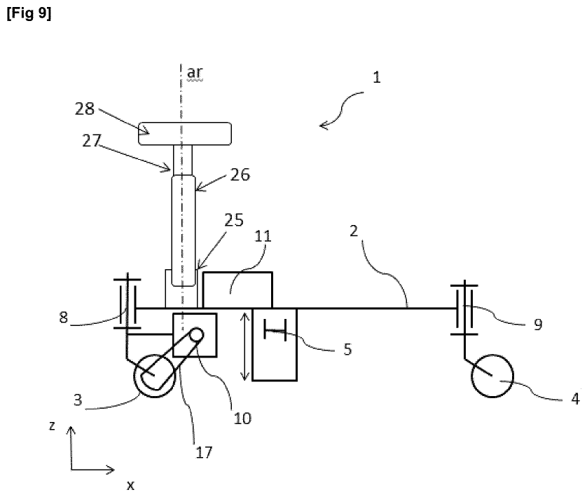

In FIG. 9, the handlebar is on the side. In top view, it is thus substantially in position 20′″ of FIG. 1. In side view, the handlebar is thus oriented along axis ar. The horizontal bar of operating piece 28 is then substantially in the longitudinal direction. It can for example be positioned along one side of the rolling object (the bed for example).

Horizontal axles 29 and 30 in FIGS. 7 and 8 are substantially longitudinal (therefore not visible in FIG. 9 because concealed by the other parts of the handlebar).

1. A removable electric propulsion system for a rolling object (13), said propulsion system (1) comprising a frame (2) provided with at least one wheel (3) driven by an electric machine (10), and at least one non-driven wheel (4), a handlebar (20) and means (5) for coupling said propulsion system to said rolling object (13), said coupling means (5) comprising means for gripping and lifting at least one wheel of said rolling object (13), said handlebar (20) comprising a connection with said frame (2) and/or said driven wheel (3), characterized in that said connection comprises a means (12, 40) for locking/unlocking said handlebar (20) relative to said frame (2) and/or to a driven wheel (3) from at least one locking position where handlebar (20) is attached to said frame (2) and/or to said driven wheel (3), this at least one locking position (22′) of said handlebar (20) enabling electric propulsion system (1) to be moved by means of said handlebar (20), to an unlocking position (22″) enabling at least free motion of said handlebar (20) relative to said frame (2) or to said driven wheel (3).

2. A system as claimed in claim 1, wherein said locking/unlocking means (12, 40) comprises an axle, said axle being preferably attached to frame (2) or to said driven wheel (3).

3. A system as claimed in claim 1, wherein said locking/unlocking means (12, 40) comprises two locking positions, a first locking position connecting said handlebar (20) to said frame (2) and a second locking position connecting said handlebar (20) to said driven wheel (3), the locking/unlocking means preferably comprising a dog clutch (42).

4. A system as claimed in claim 1, wherein said coupling means (5) comprise means for orienting at least one wheel of said rolling object (13) in a direction forming a non-zero angle with the longitudinal direction (x) of said frame of said propulsion system (1), preferably, said coupling means (5) comprise means for orienting at least one wheel of said rolling object (13) in a direction substantially perpendicular to the longitudinal direction (x) of said frame (2) of said propulsion system (1).

5. A system as claimed in claim 1, wherein said electric propulsion system (1) comprises a control means for controlling said locking/unlocking means (12, 40).

6. A system as claimed in claim 1, wherein said handlebar (20) comprises an arm, the arm being preferably articulated.

7. A system as claimed in claim 6, wherein the arm comprises a connecting piece (25) and a rod (26), said connecting piece (25) comprising said locking/unlocking means (12, 40), and said rod (26) being articulated relative to said connecting piece (25) around a first horizontal axle (30).

8. A system as claimed in claim 7, wherein said handlebar (20) comprises an operating piece (28) and a blocking/unblocking means, said blocking/unblocking means connecting said operating piece (28) to said rod (26).

9. A system as claimed in claim 5, wherein said control means controls said locking/unlocking means (12, 40) and said blocking/unblocking means, preferably simultaneously.

10. A system as claimed in claim 8, wherein said blocking/unblocking means comprises at least two configurations, a first configuration wherein said operating piece (28) is pivotally connected around a second axle (29) relative to said rod (26), and a second configuration wherein said operating piece (28) is rigidly attached to said rod (26).

11. A system as claimed in claim 1, wherein said handlebar (20) comprises a control panel.

12. A method for retracting said handlebar (20) of an electric propulsion system (1) as claimed in claim 1, wherein at least the following steps are carried out:
unlocking said locking/unlocking means (12, 40), said handlebar (20) can then move freely relative to said frame (2) and/or to said driven wheel (3),
moving said handlebar (20).

13. A method as claimed in claim 12, wherein the steps are carried out after coupling said rolling object (13) to said removable electric propulsion system (1).

14. A method for retracting said handlebar (20) of an electric propulsion system (1) as claimed in claim 8, wherein at least the following steps are carried out:
unlocking said locking/unlocking means (12, 40), said handlebar (20) can then move freely relative to said frame (2) and/or to said driven wheel (3), and moving said handlebar (20), wherein said blocking/unblocking means is unblocked, preferably simultaneously with unlocking said locking/unlocking means (12, 40).

15. A method as claimed in claim 14 wherein, after moving said handlebar (20), said operating piece (28) is pivoted.

16. A method for steering removable electric propulsion system (1) as claimed in claim 1 by means of said handlebar (20), wherein at least the following steps are carried out:
connecting said handlebar (20) to said frame (2) and/or to said driven wheel (3), preferably automatically or semi-automatically, using said locking/unlocking means (12, 40), said handlebar (20) being rigidly attached to said frame (2) and/or to said driven wheel (3),
acting upon said handlebar (20) so as to move and/or orient removable electric propulsion system (1).

17. A method for retracting said handlebar (20) of an electric propulsion system (1) as claimed in claim 8, wherein at least the following steps are carried out:
unlocking said locking/unlocking means (12, 40), said handlebar (20) can then move freely relative to said frame (2) and/or to said driven wheel (3), and moving said handlebar (20), wherein said operating piece (28) is blocked at said rod (26) by said blocking/unblocking means, preferably simultaneously with locking said handlebar (20) at said frame (2) and/or said driven wheel (3) using said locking/unlocking means (12, 40).
